(19) United States
(12) Patent Application Publication
(10) Pub. No.: US 2007/0266332 A1
(43) Pub. Date: Nov. 15, 2007

(54) System, method and software for displaying visual cues

(75) Inventor: Joseph Jubinski, Srkesville, MD (US)

Correspondence Address: Steptoe & Johnson LLP, 1330 Connecticut Avenue, N.W., Washington, DC, 20036, US

(73) Assignee: General Dynamics Advanced Information Systems, Inc., Arlington, VA (US)

(21) Appl. No.: 11/431,927

(22) Filed: May 11, 2006

(51) Int. Cl. G06F 3/048

(52) U.S. Cl. 715/766

(57) ABSTRACT

One embodiment of the invention relates to a system, method and software for displaying visual cues to an end-user based on indicia received from a remote source. More particularly, the present invention relates to displaying visual cues on a display coupled to a fixed function processor. According to one embodiment, the fixed-function processor-based system may include an input/output interface. The fixed-function processor-based system may also include a memory including processor-readable software code configured to permit the processor-based system to perform a fixed-function and processor-readable software code configured to enable the fixed-function processor-based system to prioritize a number of visual cues based on an importance factor associated with the application task. The fixed-function processor-based system may also be configured to execute the fixed function and to prioritize the plurality of visual cues based on the importance factor. Moreover, the fixed-function processor-based system may also include a display, the display being configured to display visual cues in a manner based on the importance factor associated with a cue event received via the input/output interface. Also described are methods for displaying visual cues in fixed-function processor-based systems and processor-readable software code for the same.

### FIELD OF THE INVENTION

The present invention relates to a system, method and software for displaying visual cues to an end-user based on indicia received from a remote source. More particularly, the present invention relates to displaying visual cues on a display coupled to a fixed-function processor.

### BACKGROUND OF THE INVENTION

Users of fixed-function processor-based systems may be faced with certain problems that require troubleshooting. Some such systems may be windows-based systems where the user may have a number of different windows open, each of the windows being associated with one or more application programs. These windows may display a wide variety of data to the end-user. The end-user is required to be able to determine what information is in which window and should be able to independently understand how to use that data in performing a particular job or task.

For example, a power-plant operator may have a workstation or personal computer that is configured to perform a fixed-function, such as monitoring the status of a power plant. In conventional systems, the user may be presented with the data in a windows-based form or some other form, and may be required to toggle between multiple screens to see all of the relevant data, such as, for example, area maps, sectors of a give power plant, water temperature, or information related to other cooling systems, power production levels and power requirements and the like.

In some cases, the power-plant operator may be faced with a problem that requires some form of trouble shooting. In the event of such a problem, the operator may be required to call up multiple screens or sources of data and review that data to determine exactly what the problem is and how to solve that problem. Thus, the operator must know where to look in the system based on where in the power-plant or what device the alarm is being generated by. In trying to access the appropriate sources of information, the power-plant operator may be wasting time and resources that may be better spent dispatching technicians to solve the problem or to rectify the problem remotely, if possible.

One way of solving this problem may be to include a sort of a trouble shooting guide that guides the user step-by step thorough a fix of a perceived problem. The trouble with this approach is that the user is bound to follow the instructions provided by the computer system and therefore does not exercise independent discretion. Such a “foolproof” system may in fact lead to more mistakes due to lack of proper training for power-plant operators and the inability for the operator to use their training and independent discretion to diagnose and solve problems.

This problem is not unique to power-plants and is present in numerous applications where end-users of fixed function processors are presented with numerous sources or forms of data and must use that data to diagnose and solve problems. Other such applications may include a wide variety of industrial or manufacturing facilities, for example. Another such example is an airplane pilot, where the pilot may be presented with data from numerous gauges, lights and displays and may, in the event of a problem, need to identify the appropriate gauges to solve a particular problem.

Therefore, what is needed is a system, method and software for displaying visual cues to an end-user of a fixed-function processor-based system that is configured to call the appropriate information to the end-users attention in the event that a problem or some other event occurs. It may also be preferable if the system, method and software were to be configured to provide the end-user with this information in a priority-based or importance-based manner based on the indicia received from a remote location.

### SUMMARY OF THE INVENTION

The present invention relates to a system, method and software for displaying visual cues to an end-user based on indicia received from a remote source. More particularly, the present invention relates to displaying visual cues on a display coupled to a fixed-function processor.

The present invention relates to a system, method and software for displaying visual cues to an end-user based on indicia received from a remote source. More particularly, the present invention relates to displaying visual cues on a display coupled to a fixed function processor. According to one embodiment, the fixed-function processor-based system may include an input/output interface. The fixed-function processor-based system may also include a memory including processor-readable software code configured to permit the processor-based system to perform a fixed-function and processor-readable software code configured to enable the fixed-function processor-based system to prioritize a number of visual cues based on an importance factor associated with the application task. The fixed-function processor-based system may also be configured to execute the fixed function and to prioritize the plurality of visual cues based on the importance factor. Moreover, the fixed-function processor-based system may also include a display, the display being configured to display visual cues in a manner based on the importance factor associated with a cue event received via the input/output interface.

According to one embodiment of the invention, a fixed-function processor-based system may be configured to receive an input from a remote device. This input may be indicative of an event occurring at a location remote from the fixed-function processor. According to another embodiment of the invention, the event may be a malfunction of a device, component or piece of equipment, for example or a failure of a device, component or piece of equipment.

According to another embodiment of the invention, the fixed-function processor may include a remote device coupled to the input/output interface. The fixed-function processor-based system may also include a trigger service module being configured to validate and map an incoming cue event received via the input/output interface. The fixed-function processor-based system may also include a layout parser module that may be configured to read a layout associated with the display. Additionally, according to this embodiment of the invention, the fixed-function processor-based system may also include a plug-in framework module configured to search a rules engine for a rule associated with the received cue event and to execute that rule and to output a visual cue. Moreover, the invention may also include a display module configured to receive the visual cue received from the plug-in framework module and to configured the display based on the visual cue.

According to yet another embodiment of the present invention, the fixed-function processor-based system may also include a plug-in module configured to receive a cue event from a remote device via the input/output interface. The plug-in module may be configured to determine an importance factor associated with the cue event. The fixed-function processor-based system may then be configured to search a rules database using, for example, software code associated with the plug-in module for a set of rules associated with the received cue event. The rules may be configured to dictate what information is displayed on the display of the fixed-function processor-based system and may also dictate what order that information is displayed. According to one embodiment, a plug-in module may be configured to receive a cue event from a remote device via the input-output interface. The plug-in module may also be configured to determine the importance factor based on the received cue event.

According to yet another embodiment of the present invention, the fixed-function processor-based system may also be configured to search a rules database for a set of rules associated with the received cue event. Additionally or in the alternative, the rules database may be configured to include a number of rules associated with predetermined cue events. These rules may be associated with one or more sources of information viewable to an end-user. When a rule is accessed based on the cue event, the one or more sources of information may be displayed to the user in a predetermined order of priority. Alternatively, the rules database may be configured to display one or more sources of information to a user simultaneously. The present invention may be employed in a number of different applications such as, for example, on an airplane, in a power plant, or other industrial facility.

According to another embodiment, the invention may include a method of prioritizing visual cues in a fixed-function processor-based system. The method may include a step of executing a first application task and executing a second application task. The first application task and the second application task may be executed such that the execution of the two tasks coincide with one another—i.e., they may be operating on the fixed-function processor-based system concurrently. The method may also include a step of receiving a cue event associated with an action to be performed using one of the application tasks. The method may also include a step of determining an importance factor associated with at least the first or second application task. This importance factor may be associated with the action that needs to be performed. The method may also include a step of displaying at least one of the first application task or the second application task based on the importance factor.

Additionally or in the alternative, the step of displaying may include displaying all user-viewable information associated with the action to be performed in an order based on the importance factor. Alternatively, the step of displaying may include displaying all user-viewable information associated with the action to be performed simultaneously. According to yet another embodiment of the invention, the step of displaying may be performed in a windows-based system and a window including information associated with the highest importance factor may be displayed on top of the other windows. Alternatively, the step of displaying may be performed in a windows-based system and a window including information associated with the highest importance factor may be displayed while windows having lower importance factor are not displayed until the user requests the window with a lower importance factor. The present invention may be implemented in a variety of applications, including, for example, an industrial facility or a power plant.

According to another aspect of the present invention, processor-readable software code may include code to receive a cue event from a remote location via an input/output interface. The processor-readable software code may also include code to perform a fixed-function on a fixed-function processor-based system. The processor-readable software code may also include code to read a layout associated with a display of the fixed-function processor-based system. The processor-readable software code may also include code to search the rules database based on the received cue event. The processor-readable software code may also include code to execute a rule located based on a search of the rules database. The rule may be associated with the cue event. Moreover, the processor-readable software code may also include code to display visual cues based on the rule.

According to yet another embodiment, the rules database may include a number of rules stored on a computer-readable medium. These rules may be associated with one or more sources of information. These sources of information may be viewable on a display of the fixed-function processor-based system. According to one embodiment of the invention, the executed rule may be configured to display visual cues to a user based on an importance factor associated with one or more sources of information viewable on a display. The code to perform a fixed function may also include code to display a number of windows including a first, second and third window. The executed rule may include instructions to display the first window on the display over the second and third windows based on an importance factor associated with at least the first window and the second window. According to yet another embodiment the code to perform a fixed-function may include code to display a plurality of windows including a first window, a second window, and a third window. The executed rule may also include instructions to display the first window and the second window simultaneously over the third window, based on an importance factor associated with at least the first window and the second window. The processor-readable software code may also include code configured to illuminate a source of information on an instrument panel.

### BRIEF DESCRIPTION OF THE DRAWINGS

While the specification concludes with claims particularly pointing out and distinctly claiming the present invention, it is believed the same will be better understood from the following description taken in conjunction with the accompanying drawings, which illustrate, in a non-limiting fashion, the best mode presently contemplated for carrying out the present invention, and in which like reference numerals designate like parts throughout the Figures, wherein:

FIG. 1 is a functional block diagram of a fixed-function processor-based system according to one aspect of the invention;

FIG. 2 is a flow chart showing an exemplary method that may be employed by a fixed-function processor-based system according to one embodiment of the invention;

FIG. 3 is a flow chart showing another exemplary method that may be employed by a fixed-function processor-based system according to one embodiment of the invention;

FIG. 4 is a flow chart showing an exemplary method of obtaining and executing a rule to display a visual cue based on a received cue event according to one exemplary aspect of the present invention;

FIGS. 5A-5C are exemplary display layouts as may be used on a fixed-function processor-based system's display when the fixed-function processor-based system operates on a windows-based platform;

FIG. 6 shows an exemplary embodiment of an orchestrator service according to one embodiment of the invention;

FIG. 7 shows an exemplary embodiment of an orchestrator service used in conjunction with hardware and software modules used in a windows-based fixed function processor-based system according to an exemplary aspect of the present invention;

FIG. 8 shows a display or GUI that may be used in connection with a fixed-function processor-based system employing the present invention; and

FIG. 9 shows an airplane cockpit employing one embodiment of the present invention.

### DETAILED DESCRIPTION OF THE INVENTION

The various embodiments of the invention will now be described more fully with reference the to the Figures in which exemplary embodiments of the present invention are shown. The subject matter of this disclosure may, however, be embodied in many different forms and should not be construed as being limited to the embodiments set forth herein.

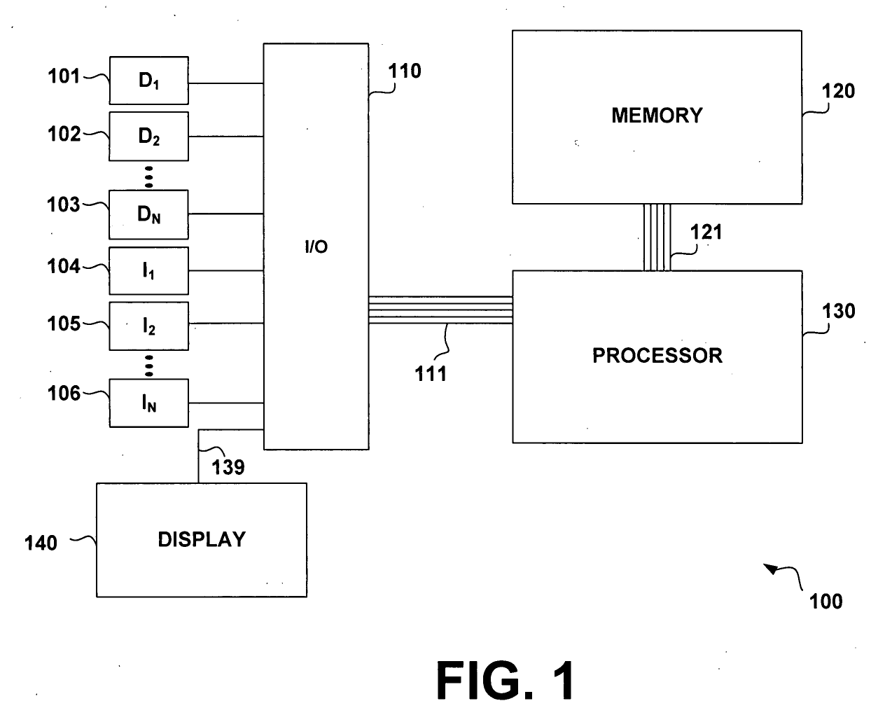

FIG. 1 is a functional block diagram of a fixed-function processor-based system 100 according to one aspect of the invention. The fixed-function processor-based system 100 may include an input/output (“I/O”) interface 110. The I/O interface 110 may be coupled to one or more devices. For example, the I/O interface 110 may be coupled to a first remote device (D₁) 101 and a second remote device (D₂) 102. There may be N devices such that devices D₁-D_{N}, (101-103) are coupled to the I/O interface 110. I/O interfaces are generally known to those skilled in the art of computer architecture and hardware design. The I/O interface 110 may also be coupled to a number of input devices, 104, 105, 106, such as input devices I₁-I_{N}. The input devices I₁, I₂ . . . I_{N} may be any of a number of different types of input devices. The selection of appropriate input devices 104, 105, 106 may depend on the particular application that the fixed-function processor-based system is designed to perform. For example, in an industrial setting, according to one embodiment of the invention, the fixed-function processor-based system may include input devices I₁-I_{N}, such as a computer mouse, a keyboard, a touch-screen, a track-ball, a microphone (for a fixed-function processor-based system having speech recognition capabilities), a bar-code or other type of scanner, or any of a number of other input devices capable of permitting input to be entered into the fixed-function processor-based system. In yet another embodiment of the present invention, the fixed-function processor-based system may be used in a transportation system, such as, for example, on an airplane. In that event, the input devices I₁-I_{N} may include any of the aforementioned input devices, but may more conventionally include toggle switches, buttons, dials or any of a number of known mechanical-electrical inputs.

Various I/O interfaces can be used as I/O interface 110 so long as the I/O interface is configured to receive signals from remote devices (e.g., D₁-D_{N}) and configured to receive input from an end user. The I/O interface 110 may also have associated software code stored in memory 120 for interpreting the various forms of input into the fixed-function processor-based system 100. The I/O interface 110 may also be coupled to the various input devices I₁-I_{N} and remote devices D₁-D_{N} over a communications bus, which permit the input devices and the remote devices to communicate with the fixed-function processor-based system via the I/O interface 110.

The I/O interface 110 may be coupled to the processor 130 via bus 111. The processor 130 may be any type of processor configured to execute one or more application programs, for example. As used herein the term application program is intended to have its broadest meaning and should include simple to complex diagnostic software. Moreover, application programs may include dispatching and ticket or work-order management software. Numerous application programs are possible and the present invention is not intended to be limited by the type of application programs being executed or run by processor 130. Processor 130 must, however, be a fixed-function processor. Fixed-function processors may include processors that are designated to perform a set of tasks, and are used for performing only those tasks. This does not mean that the fixed-function processor-based systems are not upgradeable, but rather that they are not intended to be similar to personal computers, which can be configured to perform a wide variety of completely unrelated tasks. One exemplary fixed-function processor 130 may be a processor for performing diagnostic routines and displaying visual cues in an aircraft. Alternatively, there may be fixed-function processors 130 for use in manufacturing lines and performing such tasks as quality control or equipment monitoring. In yet another embodiment of the present invention, fixed-function processor 130 may be configured to perform monitoring and diagnostics in a power plant, such as, for example, a nuclear power plant. There are many types of applications for fixed-function processor based-systems, and this list is merely intended to be exemplary.

Processor 130 may be coupled to a memory 120 via a bus 121. Memory 120 may be any type of a memory device, such as, for example, volatile or non-volatile processor-readable media such as any magnetic, solid-state, or optical storage media. The processor 130 may be configured to execute code stored on memory 120, such as, for example, code for performing the fixed-functions of the processor. According to one embodiment of the present invention, the code may include code to perform a first application and a second application. Memory 120 may also include data and rules associated with cue events and methodologies for displaying visual cues based on the cue events, as will be described in further detail below.

The fixed-function processor-based system 100 may also include a display 140 that is coupled to I/O interface 110 via bus 139. Numerous types of displays may be used in connection with the present invention depending on the type of application that the fixed-function processor-based system is designed to operate in. For example, in one embodiment of the present invention, the fixed-function processor-based system may be employed to monitor a power-plant. In this embodiment of the invention, display 140 may be a monitor, such as an LCD display or a cathode ray tube (CRT). Alternatively, the display may be a touch-screen display. In another embodiment of the present invention, the fixed-function processor-based system may be employed to monitor equipment and/or perform diagnostics on an airplane. In this embodiment of the invention, the display may be a back-light on a dial or gauge. Alternatively, it may be an indicator light, a LCD display, an electroluminescent display, or any other display that may be configured to give an end-user a visual cue regarding the importance of certain information being displayed to the end user.

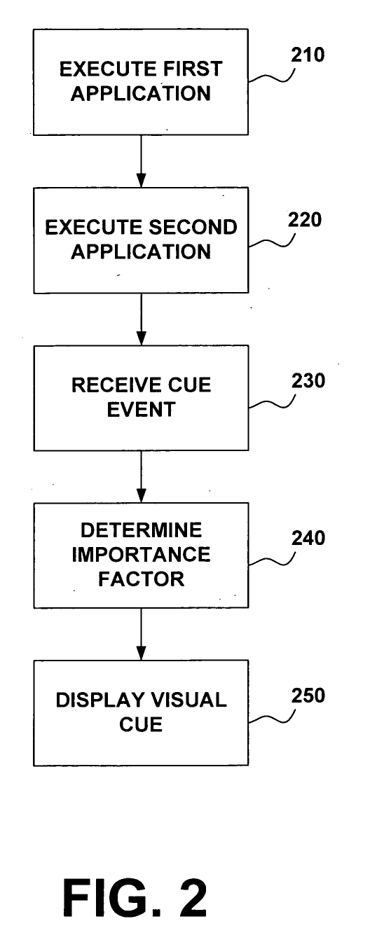

FIG. 2 is a flow chart showing an exemplary method that may be employed by a fixed-function processor-based system according to one embodiment of the invention. As shown in FIG. 2, a fixed-function processor-based system may be configured to execute a first application, step 210. The first application task may be any type of application task that the fixed-function processor-based system is configured to run as part of its operation or its fixed-function. The processor may also be configured to execute a second application, step 220. The second application may also be any type of application task that the fixed-function processor-based system is configured to run as part of its operation or its fixed-function. According to some embodiments of the present invention, steps 210 and 220 may be performed based on instructions provided from BIOS or some other start-up module. In an alternative embodiment, the instructions to perform steps 210 and 220 may be part of an operating system. Alternatively, the end-user may request that the fixed-function processor-based system execute the first application program, step 210 and execute the second application program, step 220, by, for example, providing the fixed-function processor with specific instructions to do so. For example, the end-user may enter a command at a command line or may click on an icon on a monitor or display to initiate steps 210 and 220.

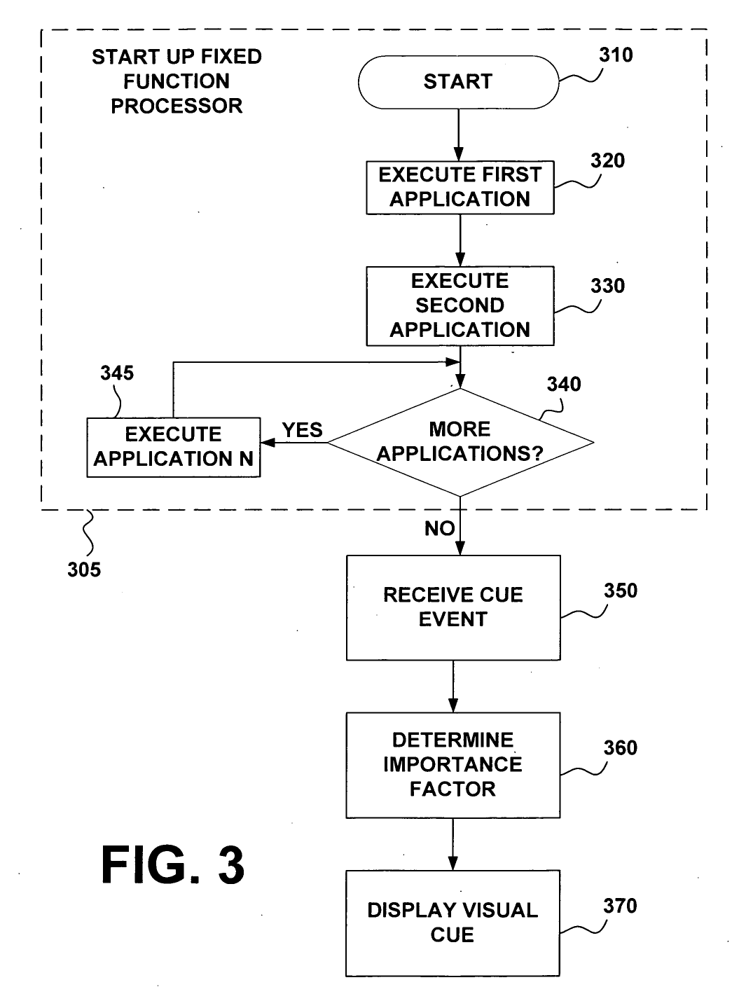

While FIG. 2 shows that the fixed-function processor-based system has executed a first application and a second application, steps 210 and 220, the fixed-function processor-based system may be configured to execute any number of application programs depending on the particular application that the fixed-function processor-based system is being employed to perform. An example of a method for performing multiple application execution is shown in FIG. 3, as described in further detail below. As shown in FIG. 2, the fixed-function processor-based system may also be configured to receive a signal indicating that a cue event has occurred, step 230. The cue event may originate at a remote device or may be caused by some event at a remote device and relayed to the fixed-function processor-based system via some electronic communications medium. In one embodiment, the cue event may originate from a remote device and rather than being transmitted to the fixed-function processor (FIG. 1, 130) via the I/O interface 110 over a communications bus, the cue event may be transmitted from the remote device via a wireless transmitter and may be received at the fixed-function processor-based system by a wireless receiver. Regardless of how the cue event is transmitted from the remote device to the fixed-function processor, the cue event should include data related to the particular event that the signal was caused by. Moreover, the cue event signal may also include data regarding a point-of-origination. This data may be stored, for example, in a packet header or may be encoded elsewhere in a data packet, for example. Alternatively, the signal may be a simple signal having, for example, a predetermined number of bits and may originate in a piece of equipment on a vehicle or aircraft. This signal may include information about where the signal originated. Alternatively, the hardware may be configured such that each device being monitored may have a unique port associated with the fixed-function processor-based system such that the processor may determine which remote device the cue event is originating from based on which port the signal is being received over. Numerous other hardware and data transmission structures may be employed in connection with the present invention.

After the fixed-function processor-based system receives the cue event, step 230, the fixed-function processor-based system may determine an importance factor associated with the received cue event, step 240. The importance factor may be associated with the cue event and may be stored in a look-up table. For example, if a cue event is received from a remote device and that cue event is representative of a critical malfunction, the importance factor associated with the cue event may reflect that the cue event must be solved as soon as possible. In this case, the importance factor may be, for example, 1000 on a scale of 1-1000. Alternatively, the importance factor may be a “1,” if the system is designed to have importance factors in reverse-numerical order. Alternatively, the importance factor may be an alpha-numerical character or other identifying symbol or character. In one embodiment of the present invention, the fixed-function processor may have an importance factor uniquely associated with each possible received cue event. This may be done because a system designer will know of the types of incoming cue event signals (i.e., each piece of equipment may only be designed to output a fixed number of error or failure signals, for example) and the system designer will be aware of all equipment in the system. Therefore, according to this embodiment of the invention, each cue event may have an importance factor uniquely associated with it (i.e., each cue event will have a predetermined number or designator). This may eliminate the possibility of having conflicting cue events that need to be addressed by the end-user at the same time. According to another embodiment of the present invention, various cue events may have the same importance factor. In the event that the fixed-function processor-based system receives two cue events that have the same importance factor, the system may be configured to resolve this conflict by addressing the first cue event received by the fixed-function processor-based system before addressing any cue events received later. In one more sophisticated system, however, the fixed-function processor-based system may be configured to determine what time the cue event was transmitted, based on, for example, a time stamp in an IPV4 packet header and address the first cue event transmitted to the fixed-function processor-based system regardless of when the cue event was received by the fixed-function processor-based system.

After the importance factor has been determined, step 240, the fixed-function processor-based system may be configured to display a visual cue to a user, step 250. According to one embodiment of the present invention, the step of displaying a visual cue, step 250, may include displaying a GUI for one or more of the applications being executed by the processor. Alternatively, the step of displaying a visual cue may include illuminating back-lights on a mechanical or electromechanical display, such as an instrument panel. Numerous other methods of displaying visual cues may be used in connection with the present invention. As will be described in more detail below, the visual cues may be displayed in an order of priority or may displayed simultaneously to a user.

FIG. 3 is a flow chart showing another exemplary method that may be employed by a fixed-function processor-based system according to one embodiment of the invention. As shown in FIG. 3, the fixed-function processor-based system may be configured to implement a start-up algorithm, shown as dashed box 305. After starting a start-up algorithm, the fixed-function processor-based system may be configured to execute a first application, step 320. After the first application is executed, the fixed-function processor-based system may then execute a second application, step 330. As shown by decision block 340, the fixed-function processor may be configured to determine if there are any other application tasks that still need to be executed. If there are more applications to be executed, the fixed function processor will execute the next application program, step 345. The fixed-function processor-based system will continue to execute application programs in this loop until there are no additional application programs to be executed, step 340. Once the application programs are executed and running on the fixed-function processor, the fixed-function processor-based system may receive an indicia of a cue event, step 350. After an indicia of a cue event has been received, step 350, the fixed-function processor-based system may be configured to determine an importance factor associated with the cue event, step 360. This may be performed according to one or more of the numerous methodologies as described above. After the fixed-function processor-based system has determined an importance factor associated with the received cue event, step 360, the fixed-function processor-based system may be configured to display a visual cue to the end-user based on the importance factor associated with the received cue event.

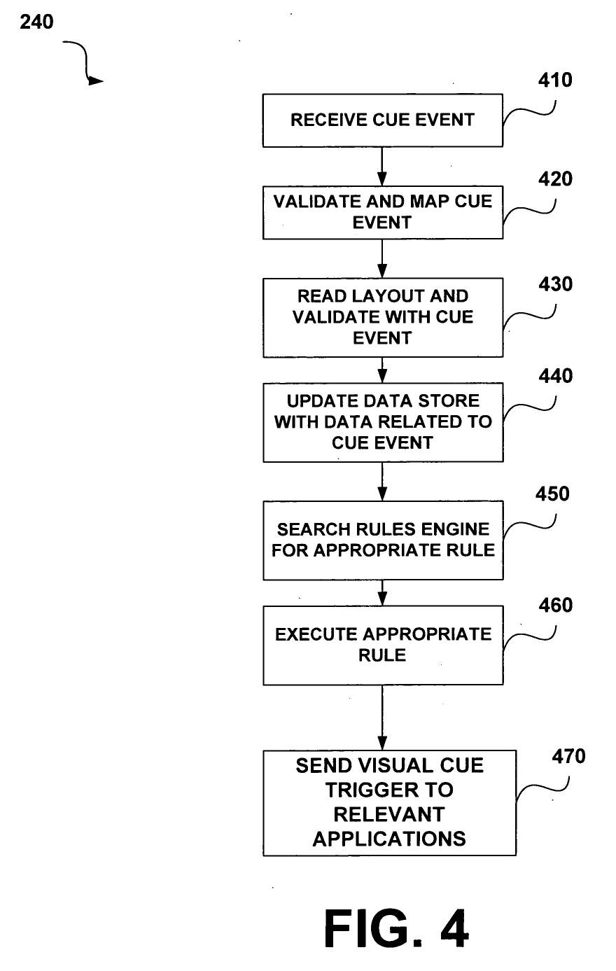

FIG. 4 is a flow chart showing an exemplary method of obtaining and executing a rule to display a visual cue based on a received cue event according to one exemplary aspect of the present invention. An exemplary method for obtaining an executing a rule to display a visual cue based on the received cue event may include receiving a cue event from a remote device, step 410. The received cue event may be transmitted via an I/O interface to a processor. The processor may be configured to implement the algorithms described herein based on computer-readable software code including the algorithms herein described. Once the cue event has been received by the fixed-function processor, the fixed-function processor may be configured to validate and map the cue event, step 420. To perform the step of validating the cue event, the fixed-function processor may be configured to determine whether the remote device that is generating the cue event is still registered with the fixed-function processor-based system. This may be performed by, for example, comparing an ID number associated with the remote device with a data structure including a list of registered remote devices. The fixed-function processor may also be configured to map the cue event, step 420, which may include cross referencing data related to the remote device and/or the cue event against a file, such as, for example, an .xml file.

After the received cue event has been validated and mapped, the fixed-function processor may be configured to read the display layout and validate that layout with respect to the incoming cue event, step 430. In reading the layout, the fixed-function processor may be configured to determine what the current layout of the display is so that this information may be used to determine what changes may need to be made to the display in connection with the incoming cue event. To validate the layout, the fixed-function processor may be configured to determine whether the appropriate sources of information, such as, for example, windows or gauges are present and active. The fixed-function processor may also be configured to update a data store with data related to the received cue event, step 440. The purpose of updating the data store may be to ensure that state-specific information related to any sources of information, such as for example, items on a display is recorded such that the information may be used in determining whether the source of information is already displayed to the user or is illuminated, for example. Additionally, the fixed-function processor-based system may also be configured to search the rules engine for an appropriate rule associated with the received cue event, step 450. The searching of the rules engine, step 450, may be performed by searching a database structure using known search algorithms. If, based on the search of the rules engine, step 450, the fixed function processor is able to locate a rule based on the received cue event, the fixed-function processor may then be able to execute that rule, step 460. In executing the rule, step 460, the fixed-function processor may be configured to send a visual cue trigger to the relevant applications, step 470. The step of sending a visual cue trigger to the relevant applications, step 470, may include sending instructions to a windows manager to display certain windows to a user. Alternatively, the step of sending a visual cue trigger to the relevant applications may include sending a visual cue trigger to an output device such that a light or actuator may be activated.

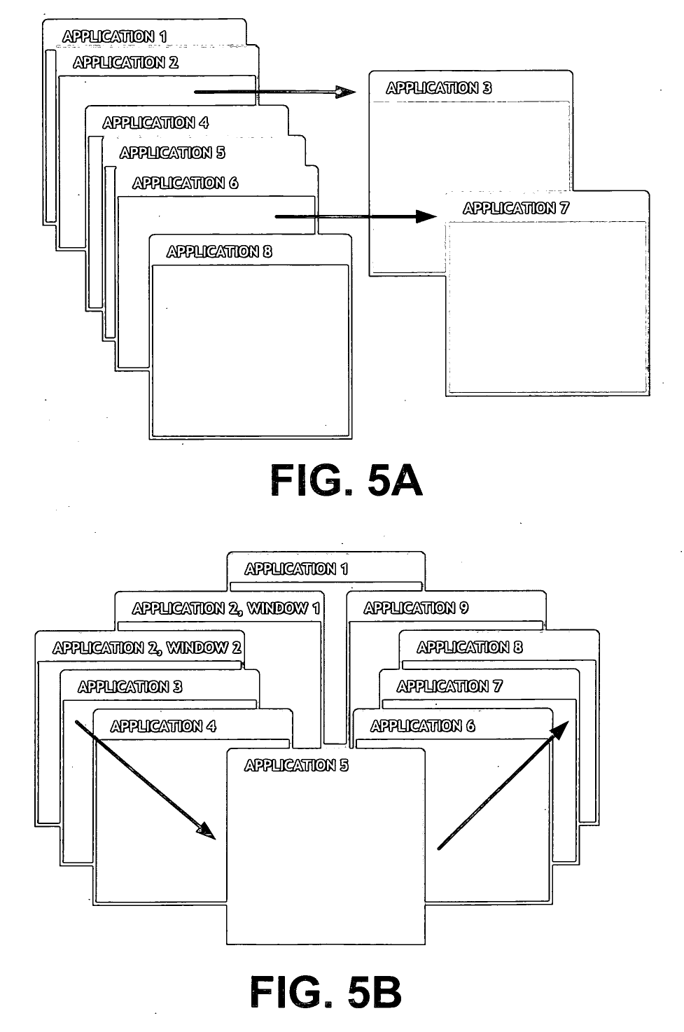

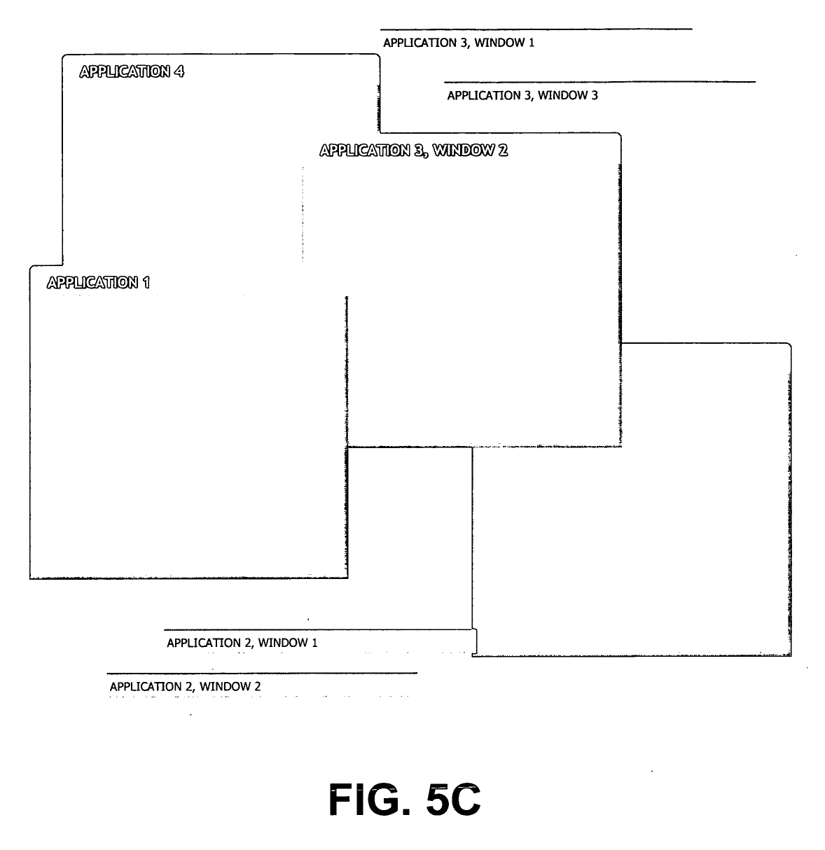

FIGS. 5A-5C are exemplary display layouts as may be used on a fixed-function processor-based system's display when the fixed-function processor-based system operates on a windows-based platform. FIG. 5A shows eight (8) separate applications, each of which may be associated with a unique window. FIG. 5A is a depiction of what may occur when a cue event is received that requires the user to be aware of the information contained in the window associated with application 3 and application 7. Thus, the fixed-function processor may be configured to display the windows associated with applications 3 and 7 on one side of the screen and may move the remaining windows to another portion of the display so that the user can clearly see the information relevant to solving the cue event. In this embodiment, the windows associated with the application program may be displayed simultaneously to the user. Additionally, while FIG. 5A shows that each application is associated with one window, it is to be understood that this is merely exemplary and that all of the windows in FIG. 5A may be associated with a single application or a given application may be associated with multiple windows.

FIG. 5B shows an alternative display method where the most relevant window, based on the importance factor, is brought to the front of all remaining windows and the user may call for the remaining windows to be circulated to the front as they are needed, based on an importance factor associated with the particular window. In this embodiment, the windows may be circulated from left to right as the user requests the windows. While the arrangement in FIG. 5B is shown with the application programs in numerical order, it is to be understood that the order that the windows are put in will depend on an importance factor associated with each window and will be based, at least in part, on the received cue event.

FIG. 5C shows yet another display method where the most relevant windows are displayed simultaneously, with the remaining windows being minimized or hidden. According to this embodiment, the rule located based on a search of the rules engine and associated with the incoming cue event may provide an importance factor associated with application 1, application 4 and application 3, window 2, and application 5. Each of these windows may have an importance factor where Application 1 is given the highest importance factor, Application 3, Window 2 is given the second-highest importance factor, Application 5 is given the third highest importance factor, and Application 4 is given the fourth highest importance factor. In one embodiment of the invention, the remaining application windows may be associated with a zero importance factor, which may be an instruction for the fixed-function processor to minimize the window. Alternatively, these windows may not be associated with an importance factor at all, and this may be an indication to the fixed-function processor to minimize these windows.

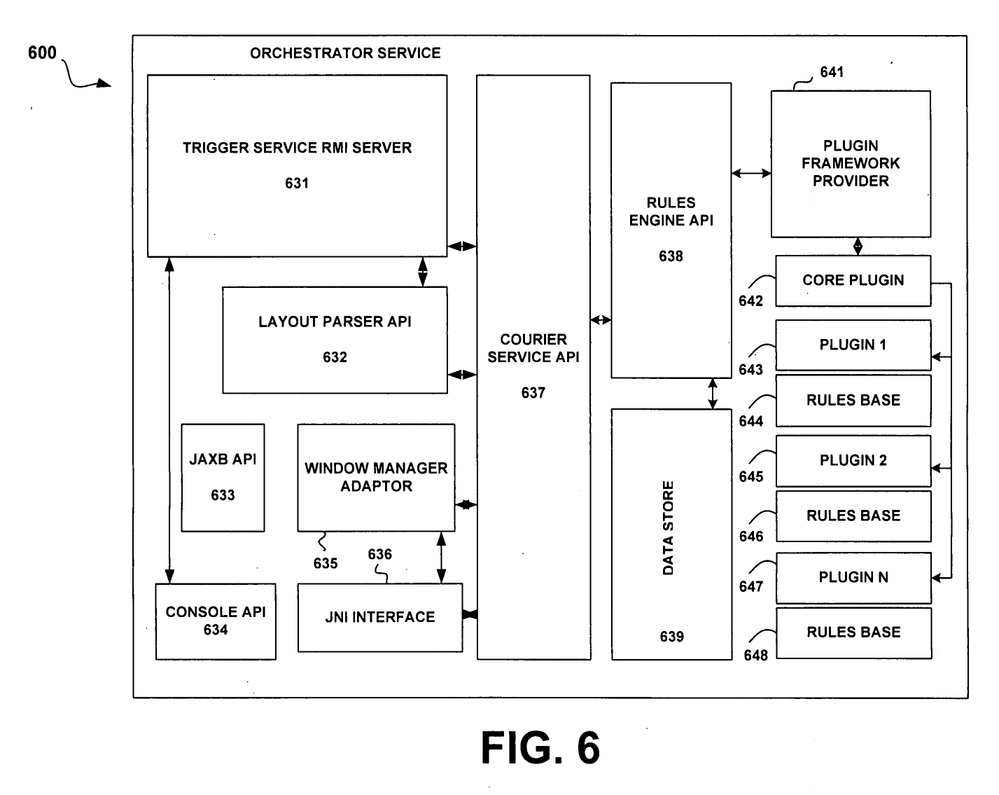

FIG. 6 shows an exemplary embodiment of an orchestrator service according to one embodiment of the invention. The orchestrator service 600 may include a trigger service 631. Trigger service 631 may be configured to receive the cue event from an I/O interface, for example. The trigger service 631 may be configured to validate and map the incoming cue event. The steps of validating and mapping were described above with respect to FIG. 4. According to one embodiment of the invention, the trigger service 631 may be configured to interface with the layout parser 632 and the console module 634. Additionally, according to the exemplary embodiment of the invention shown in FIG. 6, trigger service 631 may be configured to interface with a courier service 637. Courier service 637 may be a software module or layer that may be configured to interpret data from the trigger service 631, the layout parser 632, a window manager adapter 635, and/or a JNI interface 636. The courier service 637 may be configured to interpret data received from the aforementioned software components or modules and may ensure that the rules engine 638 may be able to interpret the received data. Additionally, the courier service 637 may also be configured to ensure that data sent from rules engine 638 can be received and interpreted by the trigger service 631, the layout parser 632, a window manager adapter 635, and/or a JNI interface 636. After a cue event is received by the trigger service 631 and it has been validated and mapped, the cue event may be transmitted to the rules engine 638 via the courier service 637. Additionally, the trigger service 631 may also interface with the layout parser 632, which may be configured to determine the current layout or configuration of the display. Additionally, layout parser 632 may be configured to determine how the display will be configured once a rule has been executed associated with the cue event.

Once the rules engine 638 receives the cue event via the courier service 637, the rules engine 638 may update the data store 639 with the current cue event information. The methods associated with updating the data store 639 were discussed above with respect to FIG. 4. The rules engine 638 may also be configured to communicate with the plug-in framework provider 641, and may provide instructions to the plug-in framework provider to search the rules engine 638 for the appropriate rule. This rule may be associated with the received cue event. If the plug-in framework provider 641 is able to locate the appropriate rule associated with the cue event, the rule may be executed. The aforementioned searching and executing steps may be performed by the plug-in framework provider 641 interfacing and interacting with a core plug-in 642, and a number of plug-ins and rules bases, 642, 643, 644, 645, 646, 647 and 648. In an embodiment of the present invention utilizing plug-ins, the fixed-function processor-based system may be updated by installing additional plug-ins and rules bases associated with new problems, or may provide additional rules to be associated with old problems that may have a new preferred solution or that have been deemed to require additional information to be displayed to the end user to assist in solving the problem. After the rule has been executed by the fixed-function processor, information may be sent to a device manager, such as, for example, the window manager adaptor 635 and may, via JNI interface 636, be output to a device for displaying the requisite visual cues based on the received cue event.

The embodiment shown in FIG. 6 is merely exemplary and is only one of a number of different software architectures that may be employed in a system and method for displaying visual cues according to the present invention. The embodiment shown in FIG. 6 is particularly suited for use in a window's based application, but as will be readily appreciated by those skilled in the art, the present invention is not limited to use in a windows-based application.

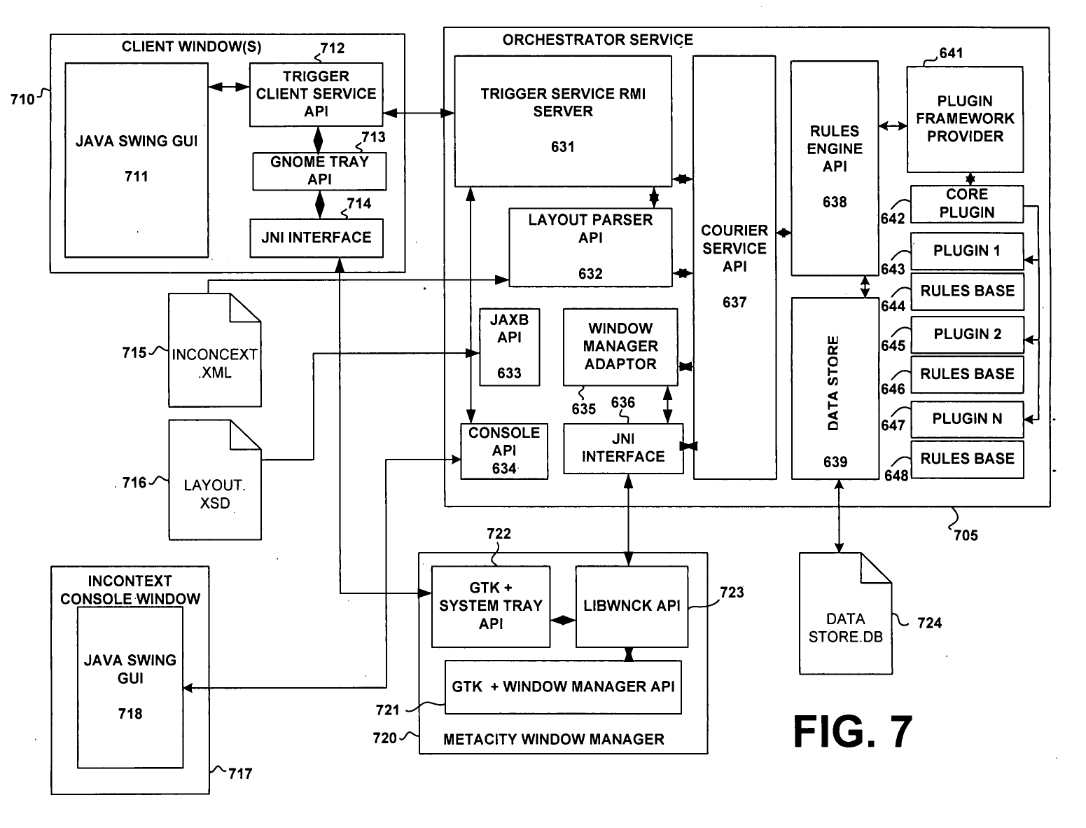

FIG. 7 shows an exemplary embodiment of an orchestrator service used in conjunction with hardware and software modules used in a windows-based fixed function processor-based system according to an exemplary aspect of the present invention. As shown in FIG. 7, a fixed-function processor-based system may include software including client window module(s) 710, incontext console window(s) 717, metacity window manager 723, data store database(s) 724, and may also include layout files 716 and incontext files 715. As will be appreciated by those skilled in the art, FIG. 7 is an exemplary software architecture for a system that was developed for a LINUX-based operating system. The orchestrator service 705 may have the same configuration as described above, with respect to FIG. 6. As shown in FIG. 7, data files such as INCONTEXT.XML 715 and LAYOUT.XSD 716 may be configured to provide data to the orchestrator service 705. For example, the INCONTEXT.XML 715 file may be configured to provide actual data, such as data from the instruments, equipment or other devices within the system to the user via the display. Thus, this file may be the source of the data that the user is to evaluate in troubleshooting the cue event. As shown in FIG. 7, this data may be provided directly to the layout parser 632. Additionally, the LAYOUT.XSD file 716 may include relevant data regarding the current display layout. This information may be provided to the JAXB API module 633 within the orchestrator service 705. As shown in FIG. 7, the JAXB API module 633 may then send this data on to the layout parser 632.

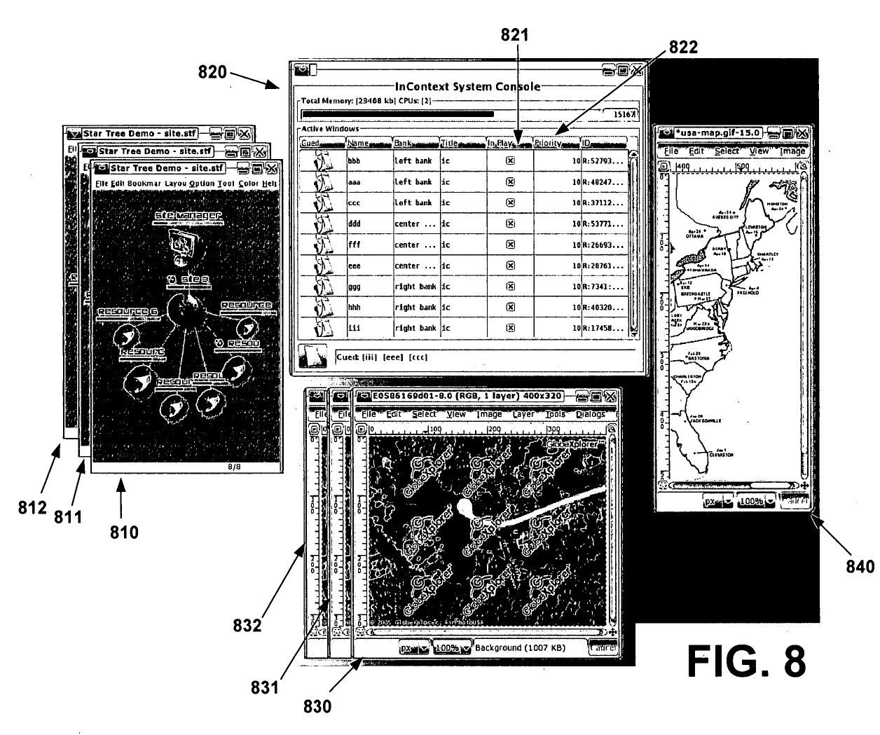

As shown in FIG. 7, according to a windows-based embodiment of the invention designed for a LINUX-based operating system, the fixed-function processor-based system may also include client window software modules 710 that may include a JAVA swing GUI module 711, a trigger client service API module 712 a Gnome gray API 713, and a JNI interface 714 the client window module 710 may be configured to interface with the orchestrator service 705 via the trigger service module 631. The system shown in FIG. 7 may also include an INCONTEXT console window module 717, which may also include a JAVA swing GUI module 718. This INCONTEXT console window module 717 may be configured to interface with the console API module 634. This module will be further described with respect to FIG. 8. Additionally, the fixed-function processor-based system may also include a Metacity Window Manager 720 that may include a GTK and system tray API 722, a Libwnck API 723, and a GTK and Window Manager API 721. These components are replaced with appropriate software, midware and hardware in embodiments of the present invention that do not employ a windows-based display.

FIG. 8 shows a display or GUI that may be used in connection with a fixed-function processor-based system employing the present invention. The GUI may include an inContext system console 820 that may be configured to summarize information related to the GUI for the user. For example, inContext system console 820 may include information related to the name of windows, the location of certain windows on the user's display as well as an indication of whether or not the window is “in play,” 821, which means that the window can be found on the display somewhere. Additionally, according to one embodiment of the invention the inContext system console 820 may include a indication of the priority or importance factor associated with a particular window, 822. This information may be updated based on the type of cue event received by the fixed-function processor-based system from a remote device. FIG. 8 shows an example of an exemplary display and GUI that may be seen by a regional, nation-wide, or world-wide manager of, for example, a system of power plants or another type of utility. As shown in FIG. 8, a left bank of windows 810, 811 and 812 may include data related to particular sites located in various geographical locations. The center bank of windows 830, 831 and 832 may include satellite photograph data related to a particular geographical area related to the various sites. The right-hand bank of windows may include a regional map of a geographical area, for example.

The types of data and the location of that data as shown in FIG. 8 is merely exemplary. The display may be configured to display any type of data depending on the particular application for which the fixed-function processor-based system is being used.

For example, a mission manager in a government agency may be responsible for mission assessment and planning and may use a fixed-function processor-based system to assist in their tasks. That mission manager may be responsible for monitoring ongoing mission activity at various different geographical locations. This mission manager, for example, may be assigned to monitor particular resources (i.e., remote devices) at each of the locations. These resources may be assigned prioritized tasks by the mission manager. Each of the geographical locations may have similar resources. Alternatively, each of the geographical locations may have different resources. While there may be local mission managers at each of the geographical locations or sites, there may be a central mission manager that is tasked with monitoring the activities at the different geographical locations. Thus, this mission manger may be tasked with finding synergies between the various resources at various geographical locations to attempt to assist in the completion of the missions in the most efficient manner possible.

This manager may be required to monitor health information and processing status information associated with the remote devices. The manger may then be required to determine what effect these factors on tasking and mission completion. The central mission manager may also have an application for performing chat-type operations with local site mangers. The central mission manger may be able to author trouble tickets or update the priorities of existing tickets based on tasking impact using a trouble ticket application, for example.

The central manger may have access to the following windows on the display of the particular fixed-function processor-based system that is being used for central monitoring and mission management purposes: an orchestrator console window; a health and status information application window; a task list application window; a chat application window; a trouble ticket application window; an address book application window; an mission planning application window and a mapping application. These types of windows are merely exemplary and there may be more windows used by the mission manager on the fixed-function processor-based system. Additionally, each of the applications may have more than one application window associated with it. According to one exemplary embodiment of the invention, the fixed-function processor-based system may receive an indication that a remote device located at a particular geographical location are being used in an inefficient manner, or in the alternative, have failed. This cue event may cause a chat screen to be called up with the local manger's user name, as well as his contact information from an address book. Additionally, health and processing status information may be called up so that the central manager can determine what the status of the remote device is. Additionally, or in the alternative, a window associated with a new ticket using the ticket manager application may be called up (in the event of a remote device failure) so that the central mission manager can issue a ticket to have the remote device repaired. Thus, when a cue event is received, the system provides the central manager with the appropriate visual cues to assist the manager in performing their job and ensuring that their job is done in the most efficient manner possible.

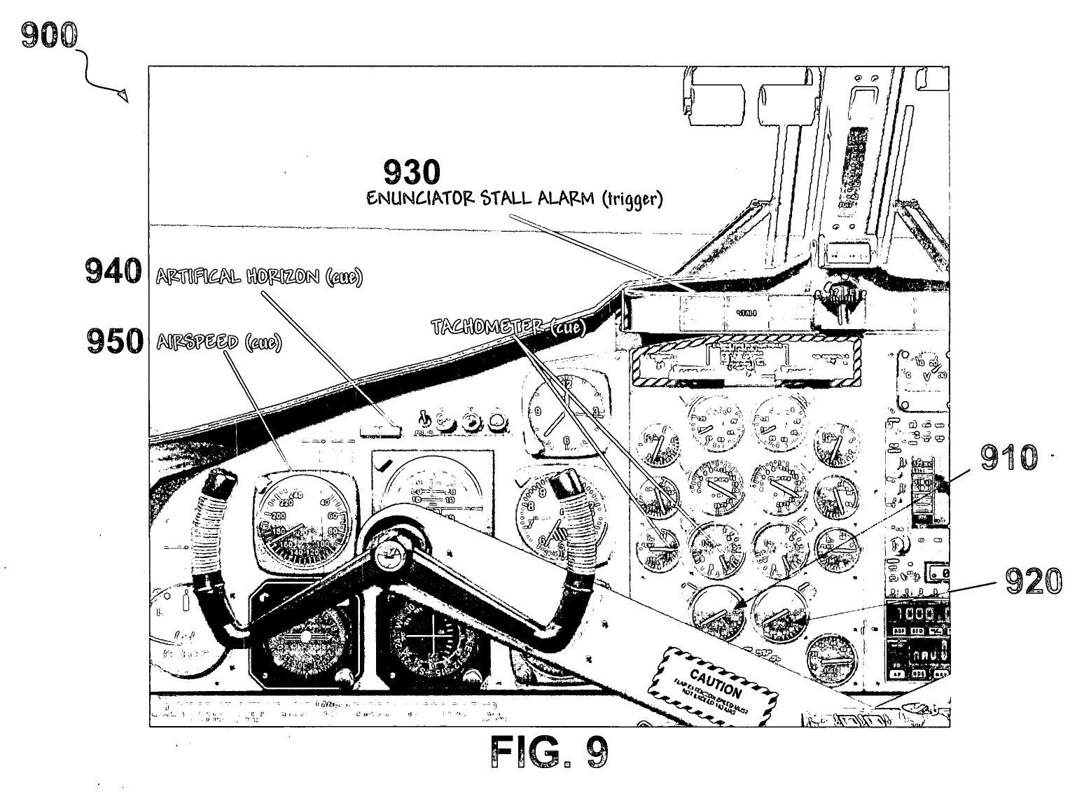

FIG. 9 shows an airplane cockpit employing one embodiment of the present invention. According to this embodiment, a cockpit may include a number of sources of information may be displayed to a pilot. In previous embodiments these sources of information were described primarily as windows or other indicia on a computer display or monitor. In this application, the sources of information may be gauges, dials and lights. In an airplane cockpit, the pilot must review a lot of data from gauges, dials, instruments and indicators. One example of where visual cues may be displayed to the pilot may be where there is a “stall condition.” In other words, where the plane stalls, the pilot must review certain information. A stall condition may occur when an increase of the angle of attack between the wing and airflow causes the lift produced to increase. This may continue until a point is reached where maximum lift is generated. This is known as the stall angle. Any further increase in the angle does not produce a corresponding increase in lift and will in fact lead to a sudden reduction in lift, a change in pitching moment or a wing drop.

According to one embodiment of the invention, the visual cue may be a halo around the particular sources of information that are relevant to solving the stall condition. Alternatively, the gauges may be backlit and a bright light may be illuminated to indicate which dials or gauges the pilot is to look at. According to one embodiment of the present invention, the system for displaying visual cues may be implemented in an aircraft by providing various groupings of components or sources of information. This layout may be described in a data file, such as, for example, an XML file. This file may be uploaded into a layout parser, for example. Various operational scenarios may then be defined and may be created via a rule base for the components or sources of information that will be governed by the visual cues. Each rule may be written in a predetermined computer language, such as, for example, JAVA with an XML wrapper. The rules may then be configured as plug-ins. Once written, the rules may be uploaded into a rules engine. Components that may be under the control of an orchestrator service (similar to that described above for a window-based system), may be registered with the rules engine module.

Next, the operation of the system, method and software for providing a pilot with visual cues following a stall event will be described. A stall sensor, as a remote device may detect a stall event. The stall sensor may then output a stall cue event to the orchestrator service. The stall alarm trigger with a rule tag of “active” may be dispatched from the stall sensor to the orchestrator. The trigger or cue event, may then be validated and mapped by the trigger service. The cue event may then be passed on to the rules engine where an appropriate rules base may be executed. After the rule is executed, cue triggers may be dispatched to the following components: an airspeed indicator 850, an artificial horizontal indicator 840, a tachometer 810, 820 and a stall alarm 830. The airspeed indicator 850, the artificial horizontal indicator 840 and the tachometer 810 may then be surrounded by a visual cue, such as, for example, a halo to signal to the pilot that they are relevant to the stall condition so that the pilot may correct the problem. Once the problem is corrected, the stall sensor may detect a normal condition and may transmit another cue event to the trigger service such that the halo lights are deactivated once the stall event has been accommodated.

While the present invention for displaying visual cues has been described with respect to certain exemplary embodiments of the invention, numerous other embodiments are also possible. It will be apparent to one of skill in the art that described herein is a novel system, method and processor-readable software code for displaying visual cues based on cue events received at a fixed-function processor-based system. This invention may be modified or varied in many ways and such modifications and variations as would be obvious to one of skill in the art are within the scope and spirit of the invention and are included within the scope of the following claims.

I claim:

1. A fixed-function processor-based system comprising:
an input/output interface;
a memory including processor-readable software code configured to permit the processor-based system to perform a fixed-function and processor-readable software code configured to enable the fixed-function processor-based system to prioritize a plurality of visual cues based on a preassigned importance factor associated with a cue event received via the input/output interface;
a processor, the processor being configured to execute the fixed function and to prioritize the plurality of visual cues based on the importance factor; and
a display, the display being configured to display visual cues in a manner based on the importance factor associated with the application task.

2. The fixed-function processor-based system of claim 1 wherein the input/output interface is configured to receive an input from a remote device, the input being indicative of an event.

3. The fixed function processor-based system of claim 3 wherein the event is a device failure.

4. The fixed-function processor-based system of claim 3 wherein the event is a device malfunction.

5. The fixed-function processor-based system of claim 1 further comprising:
a remote device coupled to the input/output interface;
a trigger service module configured to validate and map the cue event received via the input/output interface;
a layout parser module configured to read a layout associated with the display;
a plugin framework module configured to search a rules database for a rule associated with the cue event and to execute the rule and to output a visual cue; and
a display module configured to receive the visual cue received from the plugin framework module and to configure the display based on the visual cue.

6. The fixed-function processor-based system of claim 1 further comprising:
a plugin module configured to receive a cue event from a remote device via the input/output interface, wherein the plugin module is configured to determine the importance factor based on the received cue event.

7. The fixed-function processor-based system of claim 6, wherein the processor is configured to search a rules database for a set of rules associated with the received cue event.

8. The fixed-function processor-based system of claim 7, wherein the rules database includes a plurality of rules associated with a plurality of predetermined cue events, the rules being associated with one or more sources of information viewable to an end-user and when one of the plurality of rules is accessed based on the received cue event, the one or more sources of information are displayed to the user in a predetermined order of priority.

9. The fixed-function processor-based system of claim 7, wherein the rules database includes a plurality of rules associated with a plurality of predetermined cue events, the rules being associated with one or more sources of information viewable to an end-user and when one of the plurality of rules is accessed based on the received cue event, the one or more sources of information are displayed to the user simultaneously.

10. The fixed-function processor-based system of claim 1 wherein the processor is configured to run the fixed function is configured to run systems in an airplane.

11. The fixed function processor-based system of claim 1 wherein the processor is configured to run diagnostics and management software at a power plant.

12. A method for prioritizing visual cues in a fixed-function processor-based system comprising:
executing a first application task;
executing a second application task, the first application task and the second application task being executed such that the execution of the first application task and the second application task coincide with one another;
receiving a cue event associated with an action to be performed using at least one of the first application task and the second application task;
determining an preassigned importance factor associated with at least the first or second application task, the importance factor being associated with the action that needs to be performed; and
displaying the at least one of the first application task or the second application task based on the importance factor.

13. The method of claim 12, wherein the step of displaying includes displaying all user-viewable information associated with the action to be performed simultaneously.

14. The method of claim 12, wherein the step of displaying includes displaying all user-viewable information associated with the action to be performed in an order based on the importance factor.

15. The method of claim 14, wherein the step of displaying is performed in a windows-based system and a window including information associated with the highest importance factor being displayed on top of the other windows.

16. The method of claim 14, wherein the step of displaying is performed in a windows-based system and a window including information associated with the highest importance factor being displayed while windows having a lower importance factor are not displayed until the user requests the windows with a lower importance factor.

17. The method of claim 12, wherein the method includes performing the steps of executing the first application task, executing the second application task, receiving a cue event, determining an importance factor, and displaying occur on a fixed-function computer in an industrial facility.

18. The method of claim 17, wherein the industrial facility is a power-plant.

19. Processor-readable software code comprising:
code to receive a cue event from a remote location via an input/output interface;
code to perform a fixed-function on a fixed-function processor-based system;
code to read a layout associated with a display of the fixed-function processor-based system;
code to search a rules database based on the received cue event;
code to execute a rule located based on the search of the rules database, the rule being associated with the cue event; and
code to display the visual cues based on the rule.

20. The processor-readable software code of claim 19, wherein the rules database includes a plurality of rules stored on a computer-readable medium, the rules being associated with one or more sources of information viewable on the display of the fixed-function processor-based system.

21. The processor-readable software code of claim 19, wherein the executed rule is configured to display visual cues to a user based on an importance factor associated with one or more sources of information viewable on the display.

22. The processor-readable software code of claim 19, wherein the code to perform a fixed function includes code to display a plurality of windows including a first window, a second window, and a third window, and wherein the executed rule includes instructions to display the first window on the display over the second and third windows based on an importance factor associated with at least the first window and the second window.

23. The processor-readable software code of claim 19, wherein the code to perform a fixed function includes code to display a plurality of windows including a first window, a second window, and a third window, and wherein the executed rule includes instructions to display the first window and second windows simultaneously over the third window, based on an importance factor associated with at least the first window and the second window.

24. The processor-readable software code of claim 19, wherein the code to display visual cues is configured to illuminate a source of information on an instrument panel.
